(19) United States
(12) Patent Application Publication
(10) Pub. No.: US 2009/0012870 A1
(43) Pub. Date: Jan. 8, 2009

(54) Methods for driving traffic to a website

(76) Inventor: Gabriel Habeishi, Rutherford, NJ (US)

Correspondence Address: Gabriel Habeishi, 149 Mountain Way, Rutherford, NJ, 07070, US

(21) Appl. No.: 12/217,422

(22) Filed: Jul. 3, 2008

Related U.S. Application Data
(60) Provisional application No. 60/958,180, filed on Jul. 3, 2007.

(51) Int. Cl. G06Q 30/00

(52) U.S. Cl. 705/14

(57) ABSTRACT

The present invention relates to methods and systems for driving traffic to a website and providing incentives for viewers to visit and spend time reviewing a website. According to certain preferred embodiments of the present invention, methods for increasing the number of visitors to a website are provided. In general, such embodiments comprise (a) providing a website in which a party may apply for membership; (b) awarding membership to the party if the party submits sufficient information to a server via the website; (c) periodically publishing the results of a potential award within the website, wherein the results of a potential award communicate to members of the website whether all of such members will share in a payment disbursement; and (d) requiring the members of the website to view one or more pages of the website in order to view the results of the potential award.

### CROSS-REFERENCE TO RELATED APPLICATIONS

This application claims priority to, and incorporates by reference, U.S. provisional patent application Ser. No. 60/958,180, filed Jul. 3, 2007.

### FIELD OF THE INVENTION

The present invention relates to methods and systems for driving traffic to a website and providing incentives for viewers to visit and spend time reviewing a website.

### BACKGROUND OF THE INVENTION

There has been and continues to be an ongoing and rapidly growing demand for on-line businesses to implement procedures that attract customers to their websites. An e-commerce oriented website that is able to increase the amount of internet traffic within its website will have a greater audience to which to sell goods, which should translate into increased sales. Similarly, there is a demand for increasing the amount of time that such customers spend within such websites in order to, among other things, increase the probability of such customers purchasing a product within such websites (or otherwise increasing the value, and fees that may be charged for, advertising within such on-line environments).

There have been various methods deployed over the past several years to increase website traffic, including the use of a plurality of well-known “search engine optimization” (SEO) techniques, basic internet advertising, such as Google AdWords, and website linking practices. While the foregoing methods have provided a certain level of success in driving internet traffic to a particular website, there is a continuing need for new and improved methods of increasing website traffic and the amount of time that customers spend reviewing a particular website. As explained further below, the present invention addresses many of the foregoing needs.

### SUMMARY OF THE INVENTION

According to certain preferred embodiments of the present invention, methods are provided for increasing the number of visitors to a website, as well as increasing the amount of time that such visitors spend reviewing a website. Such methods generally comprise (a) providing a website in which a party may apply for membership, (b) awarding membership to the party if the party submits sufficient information to a server via the website, (c) periodically publishing the results of a potential award within the website, wherein the results of a potential award communicate to members of the website whether all of such members will share in a payment disbursement, and (d) requiring the members of the website to view one or more pages of the website in order to view the results of the potential award. According to further aspects of the invention, the website may further comprise social networking capabilities, and may provide members with a personalized account page that may be used to manage social networking memberships with a plurality of third party websites.

The above-mentioned and additional features of the present invention are further illustrated in the Detailed Description contained herein.

### BRIEF DESCRIPTION OF THE FIGURES

FIG. 1 is an example of a graphical user interface showing an on-line environment in which the methods of the invention may be carried out, which includes a listing of lottery numbers selected and purchased by the website operator.

FIG. 2 is an example of a graphical user interface, which provides a listing of winning lottery numbers.

FIG. 3 is an example of a graphical user interface showing (1) a listing of lottery numbers purchased by a website operator and (2) the winning lottery numbers for a particular draw (and draw date).

FIG. 4 is an example of a graphical user interface showing an on-line environment in which the operator of the website enters and publishes certain recently drawn winning lottery numbers.

FIG. 5 is an example of a graphical user interface showing an on-line environment in which a person may apply for membership to the website.

FIG. 6 is an example of a graphical user interface showing a means by which the operator of the website may enter and publish a plurality of purchased lottery numbers.

FIG. 7 is a flow diagram that illustrates and summarizes certain parts of the social networking methods described herein.

FIG. 8 is an example of a graphical user interface showing an on-line environment in which a person may login into the website described herein and participate in certain social networking activities.

FIG. 9 is a diagram illustrating certain systems of the present invention.

FIG. 10 is a diagram illustrating the centralized website described herein, which may be used to manage a plurality of third party social networking website memberships.

FIG. 11 is a flow chart illustrating a process described herein, whereby the website encourages communication (in a social networking environment) among its members.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

According to certain preferred embodiments of the present invention, methods are provided for increasing the number of visitors to a website, as well as increasing the amount of time that such visitors spend reviewing a website. Such methods generally comprise (a) providing a website in which a party may apply for membership, (b) awarding membership to the party if the party submits sufficient information to a server via the website, (c) periodically publishing the results of a potential award within the website, wherein the results of the potential award communicate to members of the website whether all of such members will share in a payment disbursement, and (d) requiring the members of the website to view one or more pages of the website in order to view the results of the potential award. The invention provides that the results of the potential award represent an indication of whether the operator of the website will itself make a payment disbursement to all of the members, or whether the operator of the website will distribute the winnings of a successful game of chance to all members. In other words, the invention encompasses either the operator of the website periodically paying out a reward or, alternatively, only paying out the reward to members of the website if the operator itself receives funds vis-à-vis winning a game of chance (or otherwise from a source other than the website operator). For example, the operator may communicate to members of the website that it will distribute the winnings of a winning lottery ticket if, and only if, the website operator purchases a winning lottery ticket.

The payment disbursement may be in the form of cash, such as the cash that the website operator may receive from a winning lottery ticket. Alternatively, the payment disbursement may consist of rebates or gift certificates. In certain embodiments, such rebates or gift certificates may only be redeemed by purchasing goods or services within the website through which such payment disbursement was awarded, thereby serving to increase sales of goods or services within such website.

The invention provides that members of the website may be required to view one or more pages of the website in order to view the results of the potential award, such as the set of lottery numbers selected by the operator of the website and a set of winning numbers drawn for the lottery. This way, the member is required to review more web pages, which may offer products or services for sale (and otherwise cause the member to spend more time within the website), in order to determine whether a payment disbursement will be made. Still further, the invention provides that in order to receive a share of the payment disbursement, if any, the members of the website may be required to view the results of the potential award prior to the expiration of a defined period of time. Such embodiments will therefore increase the chance of such members regularly visiting the website, thereby collectively increasing website traffic.

The means by which an individual may apply for membership to the website described herein may vary. In addition, the specific types of information that such individual must submit to the website operator (or otherwise to a server that is controlled or accessible by the website operator) may also vary. In certain preferred embodiments of the invention, an individual may apply for membership using an on-line form in which the individual enters and submits certain requested information to a server that is controlled or may be accessed by the website operator. For example, the individual may be required to submit his or her first name, last name, and e-mail address. In addition, the on-line form may require the individual to agree that the website operator shall be entitled to periodically send the individual newsletters, e-mail messages, and/or other communications to such e-mail address. The invention provides that the server may carry out an e-mail validation process, whereby upon the submission of an individual's e-mail address through an on-line form, the server sends an e-mail message to the submitted address, which the member must access, open, and acknowledge. The means by which the member may acknowledge receipt of such message, and validate his or her e-mail address, may be carried out by, for example, clicking on a hyperlink within such message, which opens a webpage in which the individual may acknowledge receipt of such message (e.g., by submitting data through another form or otherwise through the execution of a script embedded within such web page).

In the event that the results of the potential award (as posted within the website) provide that a payment disbursement will be made, e.g., if the lottery numbers purchased by the website operator represent winning lottery numbers, the members may share equally or unequally in the payment disbursement. For example, in some embodiments of the invention, all members will have the same status, such that the payment disbursement will be divided by the total number of active members and the resulting shares thereof distributed equally to each member. In other embodiments of the present invention, the members may subscribe to a particular membership level. In such embodiments, the amount (or share) of a payment disbursement that a member receives will depend on his or her membership level, whereby the website may offer two, three, four, or more different membership levels (or categories of membership).

More particularly, in certain embodiments of the invention, a party may apply for membership to any of multiple categories of membership. According to such embodiments, each category of membership may, optionally, require the party to fulfill specific duties to maintain an active membership within such category. For example, a category of membership that is characterized by requiring the performance of specific duties to maintain an active membership may entitle the members thereof to a greater share of a payment disbursement (relative to the share awarded to members of lower-ranked categories of membership that, for example, may be characterized by not requiring the performance of any specific duties). Still further, the invention provides that a higher-ranked category of membership may be entitled to a payment disbursement from a greater number of games of chance (relative to lower-ranked categories of membership). More specifically, for example, a higher-ranked category of membership may be entitled to a payment disbursement from any of ten potential winning lottery tickets, whereas a lower-ranked category of membership may be entitled to a payment disbursement from any of five potential winning lottery tickets.

According to such embodiments of the invention, the specific duties that may be required of a member to maintain his or her active status with a higher-ranked membership level may include, but are not limited to, (a) requiring a member to visit the website a certain minimum number of times during a defined period of time, (b) requiring a member to login to his or her account that is maintained within the website a certain minimum number of times during a defined period of time, (c) requiring a member to purchase a product within the website within a defined period of time, (d) referring a third party to become a member of the website, (e) entering content into a blog within a defined period of time, (f) responding to and submitting answers to surveys, or (g) any combination of the foregoing.

In addition to the significantly increased amount of time that customers will spend within a website that employs the methods of the present invention, the invention has the further advantage of attracting more individuals (visitors) to such website—regardless of whether such customers wish to buy a product. In other words, many individuals will enjoy the risk-free, cost-free, and exciting gaming experience that the present invention provides within the website. Thus, by employing the methods described herein in a website, a significantly increased number of people will be attracted to and will visit the website.

Such attraction, and increased web traffic, also translates into significant benefits for the operator of such website. Of course, if the website offers goods and/or services for sale therein, such increased internet traffic will translate into increased sales of such goods and/or services. In addition, the value of on-line advertising is often influenced and/or proportional to the amount of traffic of the on-line advertiser's website. In other words, the more traffic that a website experiences, the more so-called consumer impressions that ads shown therein will experience. It follows that if a website experiences more traffic as a result of employing the methods of the present invention, the operator of such website will be able to charge higher fees for the right to advertise in the website.

In addition, in certain embodiments of the present invention, the website offers the ability to conduct social networking and charitable activities therein, which provides yet another means for increasing web traffic to the website (and increasing the amount of time that members spend within such website). More particularly, for example, the website may comprise social networking groups, wherein each group may include people having similar interests. In addition, the website may encourage members of certain groups to contact each other on any given day using various means, e.g., the website may suggest that one member contact another based on (a) that day's astrological sign and reading, (b) each member's astrological sign (as reflected in each member's profile page), and/or (c) the other information contained in a profile page that is dedicated to each member who is encouraged to contact another member.

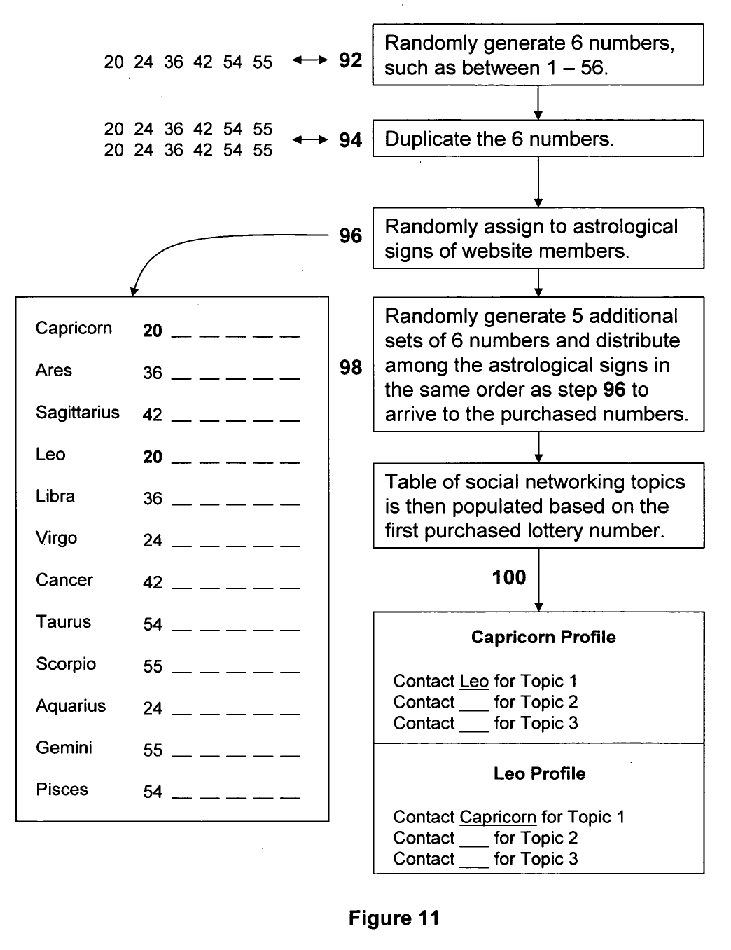

More particularly, in certain embodiments, the game of chance may be a lottery game involving a set of six numbers. The six numbers that are drawn (or selected/purchased by the operator of the website) are duplicated (to create twelve numbers—two sets of six numbers), and then randomly distributed among the twelve astrological signs. The system described herein will then match the members of the website with other members of the website (having different astrological signs), who were assigned the same lottery number. The system will then encourage the matched members to interact with each other and, for example, discuss a shared topic of interest between the members (or discuss a topic that has been pre-selected by the website). The astrological sign and/or topics of interest of each member will preferably be housed within a database, from which the server and website may extract the necessary information to carryout the above methods. The foregoing type of social networking method has been shown to increase the overall interest in the game of chance, the social network embodied in the website, and therefore, the amount of time that members spend within the website. A non-limiting example of the foregoing method is further described in the examples below, with reference to FIG. 11.

According to additional embodiments of the present invention, the website may comprise novel means of donating money (or potential winnings from a game of chance) to a charity. In certain embodiments, for example, the website may enable members to make contributions of money towards the purchase of lottery tickets. The donated money may be used, for example, to purchase additional lottery tickets above the amount that the operator of the website may purchase. The website may exhibit a running account of the money donated for any given lottery period, which is preferably visible to all website members. Preferably, the invention provides that any non-“jackpot” winnings derived from the lottery tickets (purchased with money that has been donated by members) will be (1) paid out to a charity or (2) held in an escrow account until a minimum threshold is achieved and then paid out to a charity. A running account of non-“jackpot” winnings will preferably be exhibited and visible within the website, along with the minimum threshold amount that triggers a charitable payout. The invention provides that if the lottery tickets (purchased with money that has been donated by members) result in a jackpot winning, the winnings will be distributed among the members of the website in accordance with the methods described herein.

The charity that will receive the money in the methods described above may be, for example, a charity that is democratically selected by the members of the website. In other words, the website may include an on-line form that allows members to propose and/or endorse a particular charity. In certain embodiments, each member's vote or endorsement of a charity may be valued the same as all other members; whereas in other embodiments, a member's vote or endorsement of a charity may be valued proportionally to an amount of money that he/she donates to purchase additional lottery tickets (i.e., the more money that a member donates, the more “votes” that he/she will be able to submit in support of a particular charity).

Furthermore, the website may include a personalized account page for each member, in which the member may access and manage a plurality of memberships for a plurality of third party social networking sites. Here again, such feature will serve to attract members to the website, insofar as it will serve as a centralized website from which various social networking accounts may be managed. Still further, the website may allow members to make charitable donations, either from their own monetary resources or, alternatively, from any payment disbursement that a member receives vis-à-vis the methods described herein.

The following example is provided to further illustrate the methods of the present invention. This example is illustrative only and is not intended to limit the scope of the invention in any way.

### EXAMPLE

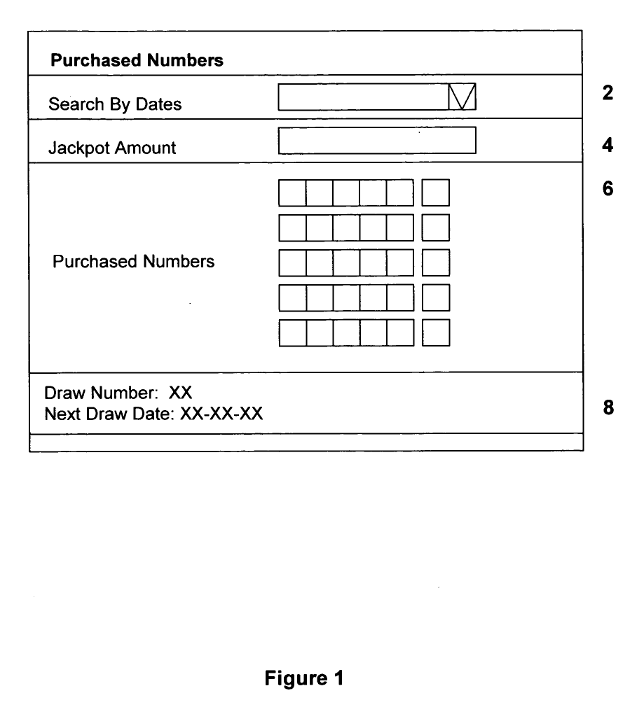

Referring to FIG. 1, an example of a publicly-accessible graphical user interface of a website (or a portion thereof in which the methods of the invention may be carried out is shown. In this Example, a listing of lottery numbers may be searched for and obtained from a database by participating website members. More particularly, the lottery numbers that have been purchased 6 (i.e., a listing of lottery numbers selected and purchased by the operator of the website), for the specified draw date 2 and jackpot amount 4, may be retrieved from a database record. As shown in FIG. 1, a drop-down menu may be employed in an on-line form, such that a user may easily query a database for the purchased lottery numbers 6 based on the specified date 2. As shown therein, the web page may further show the corresponding draw number (and next draw date) 8 for the relevant game of chance (e.g., lottery).

Still referring to FIG. 1, the visitor (internet user) may also search for and view the lottery numbers 6 selected and purchased by the operator of the website for upcoming (open) drawings, such as by using the date-oriented search function 2 shown in FIG. 1. The date-oriented search function 2 may include dates for open lottery drawings for a single type of lottery or, alternatively, a plurality of lotteries spanning across two or more states. Still further, the invention provides that the visitor may also search for and view selected (purchased) lottery numbers for previous lottery drawings, such as by using a date-oriented search function 2 shown in FIG. 1.

In this Example, as shown in FIG. 1, the website operator purchases five separate lottery tickets 6, each comprising six numbers, which are awaiting the applicable lottery drawing. The invention further provides, however, that parties other than the website operator may be responsible for purchasing the lottery ticket numbers 6. For example, in one embodiment, a third party may be responsible for purchasing the lottery tickets, whereby unrelated websites (i.e., website operators) enter into agreements with such third party which provide that the unrelated websites will receive all (or a portion of) the payout of a winning lottery ticket from the third party (which is then further distributed among the members of the unrelated websites as described herein). In such embodiments, the third party that is responsible for purchasing the lottery tickets may be paid a fee in exchange for such service (and/or retain a commission on any reward from a winning lottery ticket).

In such embodiments, the third party may provide a means for multiple websites to offer the services described herein and to drive traffic to their respective websites. In such case, for example, a prospective member may actually apply for membership to a first website (e.g., an e-commerce website that sells goods on-line) and, in doing so, is automatically enrolled in a membership to a third party website that is responsible for carrying out the methods described herein of participating in a game of chance (e.g., a lottery) and then distributing any winnings to its members. In this example, the first website may advertise that, as part of its product offerings and benefits of becoming a member of such website, customers are automatically enrolled with the third party website and, therefore, may potentially receive a payout from a successful game of chance. The invention provides that in such embodiments, the results of the game of chance may be shown in the first website as well, in order to further drive traffic to (and increase the amount of time spent within) the first website (i.e., the e-commerce website that sells goods on-line). Thus, although the present specification refers to the website operator purchasing one or more lottery tickets (or otherwise participating in one or more games of chance), the invention provides that third parties may alternatively fulfill this role and allow other website operators to enter into mutually beneficial agreements with such third parties as described herein.

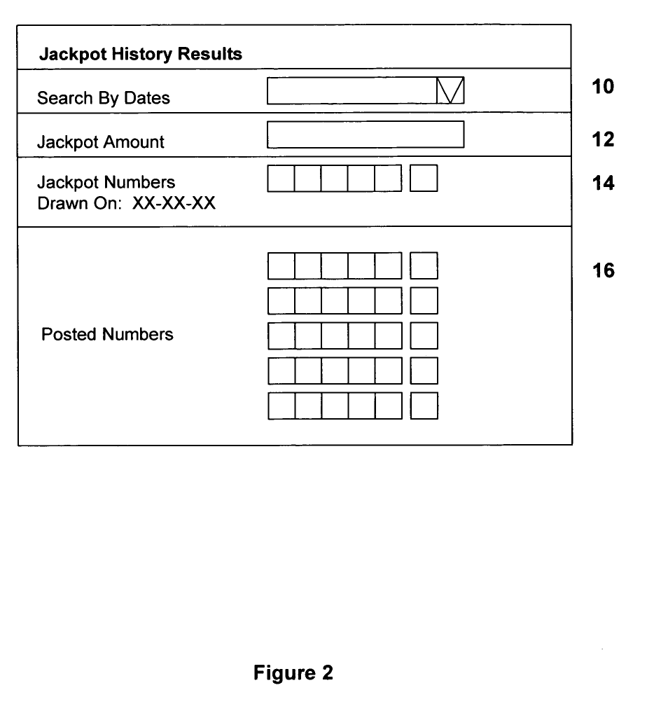

Referring now to FIG. 2, the website may further comprise a publicly-accessible web page (or a portion thereof) in which a user may search for and obtain the jackpot amount 12, winning jackpot numbers 14, and the lottery numbers purchased by the website operator 16, for a specified search date 10 (which will preferably correspond to a particular draw number). In this Example, the purchased (posted) numbers 16 and winning lottery numbers 14 may be shown in a single web page or, alternatively, the invention provides that such numbers may be spread across multiple pages, thereby requiring the viewer to visit multiple pages within the same website. For example, in order to determine whether the results of the potential award are favorable, i.e., whether the website operator's purchased lottery numbers are winning numbers, a member of the website would visit the web page shown in FIG. 2. If, for example, the posted numbers 16 were not shown therein, the user would be required to compare the winning lottery numbers 14 to the listing of posted numbers selected and purchased by the operator of the website for the relevant drawing 6 (FIG. 1) in a separate web page, which would serve to increase traffic and movement within the single website (which may itself increase the number of commercial impressions for any advertisements located in such pages). Of course, the invention provides that only one lottery ticket or a plurality of lottery tickets may be purchased by the website operator, whereby the purchased lottery numbers 16 may be published in the website (as shown in FIG. 2) along side (or in proximity of) the winning (jackpot) lottery numbers 14, thereby representing the results of the potential award.

As shown in FIG. 1, the website preferably lists the “Jackpot Amount” (or other potential award) 4 for each lottery drawing. The “Jackpot Amount” 4 shown will preferably represent the total amount of the award. The website may further specify whether such “Jackpot Amount” represents an annuity payout arrangement, a lump sum cash payment, or it may also list both payout options.

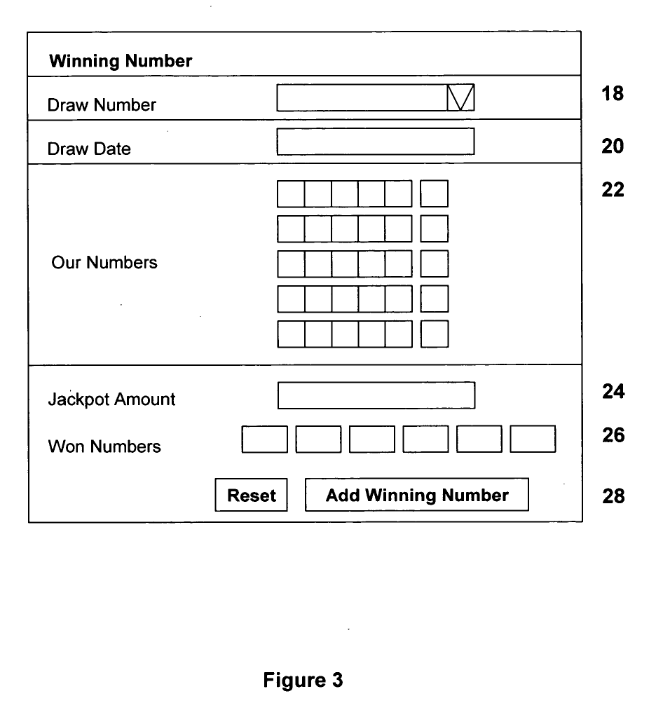

The invention further provides that systems may be used to facilitate the posting of recently purchased lottery numbers, for example, as well as recently drawn winning lottery numbers. Referring to FIG. 3, for example, a graphical user interface is shown of a web page (or a portion thereof in which new (recently purchased) lottery numbers selected by the operator of the website may be entered into a database, as well as recently-drawn winning jackpot numbers. For example, the web page of FIG. 3 may be accessible only to the website operator, and may allow the operator to specify the draw date 20, purchased lottery numbers 22, jackpot amount 24, and the winning numbers 26 for any particular draw number 18 (wherein the draw number may be obtained from a table of draw numbers 18 listed in a database).

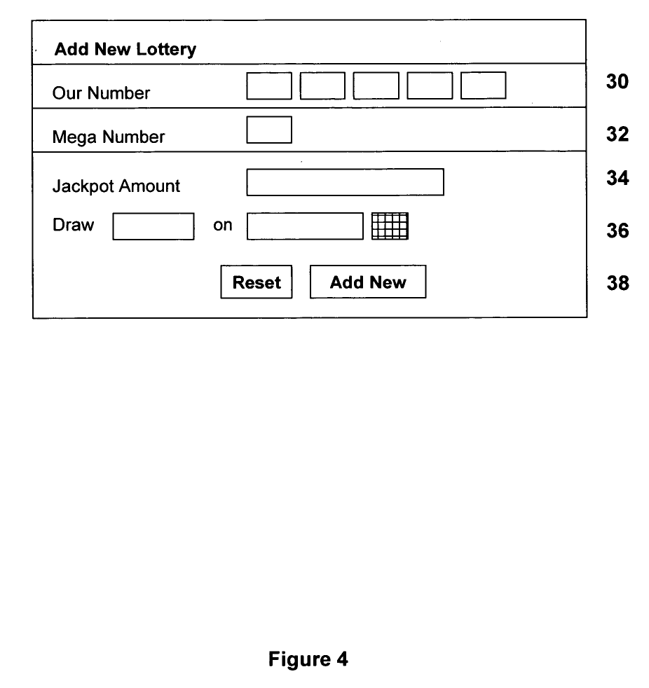

FIG. 4 illustrates an example of another graphical user interface showing a web page in which the operator of the website (or another third party that is responsible for carrying out the methods of the invention) enters and publishes certain recently purchased lottery numbers, e.g., prior to the applicable winning lottery numbers being drawn. More particularly, the web page may be accessible only to the website operator, and may allow the operator to publish (within the publicly-accessible part of the website) certain recently-purchased lottery numbers 30, including a mega number (or so-called “power ball” number that is sometimes associated with lottery games 32), the jackpot amount 34, draw number and draw date 36. The invention provides that by executing a script, e.g., by clicking the “Add New” button 38 shown in FIG. 4, the entered data (recently purchased lottery numbers) are transferred to a second table within a database, which are then published within a publicly-accessible part of the website, such as the web page shown in FIG. 1.

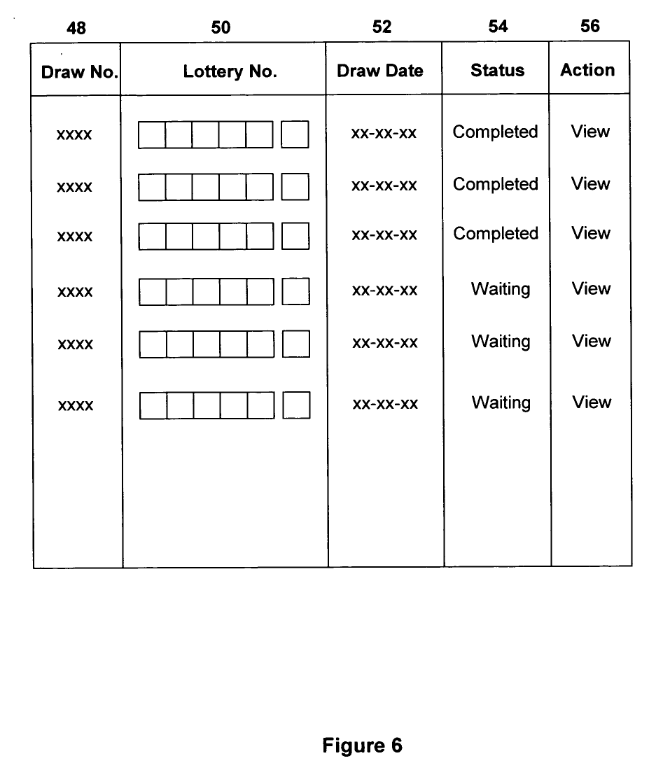

FIG. 6 is an example of a graphical user interface showing an on-line environment in which the operator of the website may view and manage a plurality of lottery numbers that it has purchased for a plurality of lottery drawings. The type of summary page shown in FIG. 6 may list, for example, the draw number 48, purchased lottery number(s) 50, draw date 52, status 54, and link(s) triggering one or more action items 56 that may apply to a particular draw number 48.

The invention provides that the forms shown in FIGS. 3, 4 and 6 have been shown to enable an operator of a website (or another third party that is responsible for carrying out the methods of the invention) to efficiently and accurately publish new purchased lottery numbers (and recently drawn winning lottery numbers) in a website environment. The web pages of FIGS. 3, 4 and 6 will preferably be accessible only by an authorized website operator (or a representative or agent thereof), such as by requiring that an authentic and valid username and password be submitted to a server through an on-line form (which a server will verify is listed in a database table of authorized users prior to granting access to such web pages).

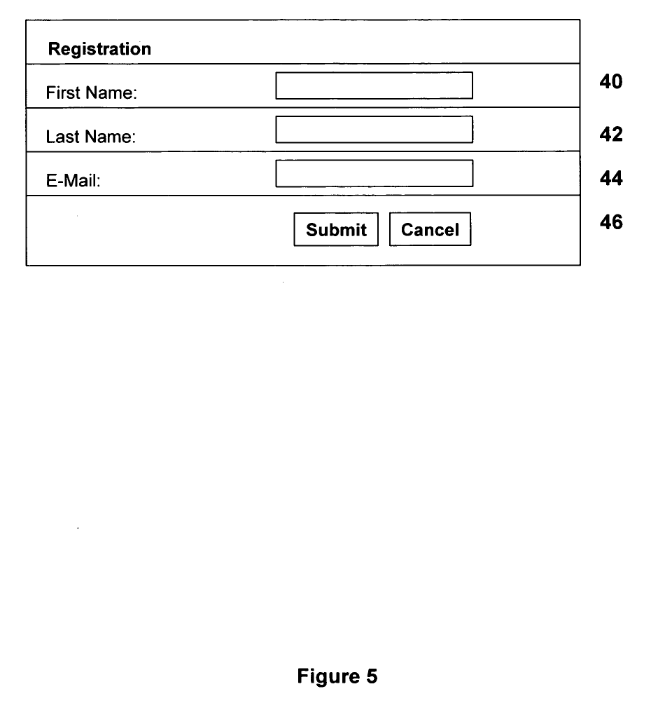

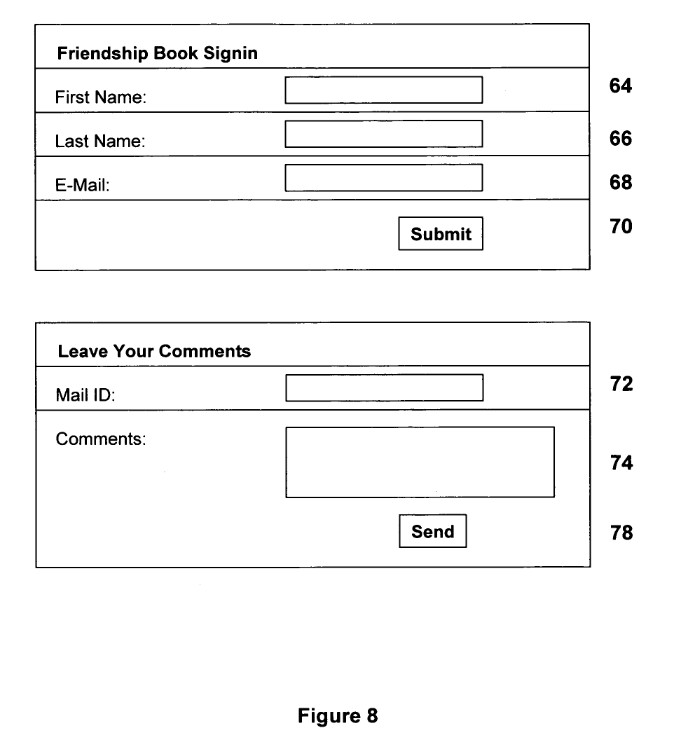

In addition, and referring now to FIG. 5, the website may include an on-line form which provides a means by which a visitor may apply for membership with the website, by submitting 46 his or her first name 40, last name 42, and e-mail address 44. Still further, the website may further include certain on-line forms in which visitors may enter and submit comments to the website operator regarding the lottery drawings, or other games of chance, which are carried out in the website. Such on-line forms may be used by members and/or non-members to submit a message to the website operator or other members of the website. As described below, in certain embodiments of the invention, the website further includes certain social networking functionalities, which further serve to increase web traffic within such website. FIG. 8, for example, shows two portions of a web page, which allow a user to show that he/she visited the website by submitting and publishing 70 his/her first name 64, last name 66, and email address 68—in a type of on-line guest book. Still further, the website may employ a form that enables a user to enter a type of username 72, a series of comments 74, and then submit 78 the comments for publication within the website.

As described above, a primary benefit of the present invention is increasing traffic to websites that employ the methods described herein. In addition to encouraging existing members to periodically visit such websites in order to view the results of a potential reward (e.g., to learn whether the website operator selected winning lottery numbers and will issue a payment disbursement), the invention may be used to encourage new non-members to visit the website. For example, a third party website may advertise the opportunity to become a member of the website described herein and potentially share in a potential payment disbursement (e.g., share in the award of a winning lottery ticket). Of course, such methods will serve to further drive new traffic of new visitors to the website.

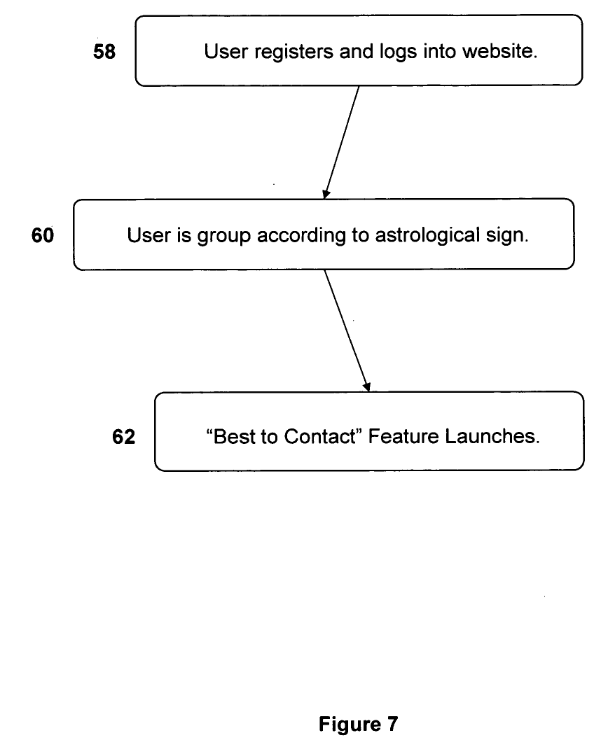

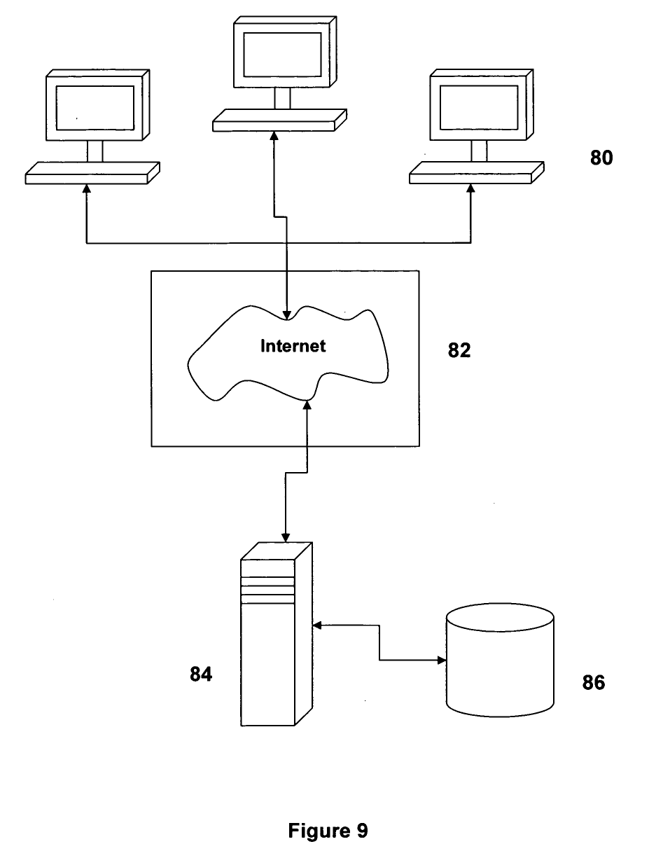

In certain additional embodiments of the present invention, the website described herein comprises social networking functionalities. Non-limiting examples of such functionalities may include the ability to create and publish personalized sub-web pages, communicate with other members (or groups of members) via e-mail, message boards, on-line chat, or other communication means, and other networking functions. In certain embodiments, the website may employ certain methods to group website members together, and to encourage communication between such members. For example, and referring to FIG. 7, when a user registers with the website 58 and becomes a member thereof (such as by using the on-line form of FIG. 5), the member may be required to provide a server with his/her astrological sign 60, which is then stored in a database for future use. As described below, the server may utilize the astrological sign 60 that is recorded for each member, to periodically encourage communication with other members 62. The general architecture of the websites and systems described herein should be appreciated by those of ordinary skill in the art. More specifically, for example, referring to FIG. 9, members will access the website through their own personal computer (or other computing device) 80, through an internet connection 82. The website described herein will be hosted within one or more servers 84, which will further comprise (or be capable of communicating with) a database 86 that stores the various types of information described herein, such as lottery draw numbers, draw dates, jackpot amounts, purchased lottery numbers, winning lottery numbers, member information (including first name, last name, email address, and astrological signs), etc.

As mentioned above, the website and server described herein may periodically encourage communication among its members (and/or among members within certain groups or members sharing something in common with each other). For example, based on the astrological sign that is recorded for each member, the website may encourage communication with other members. Referring to FIG. 11, for example, the means by which the purchased lottery numbers are selected by the website operator may be incorporated into this social networking functionality, in order to draw further attention to the game of chance and social networking, which further encourages website traffic therein.

More particularly, as shown in FIG. 11, the process may begin by the server randomly generating six numbers 92 (such as between 1-56), duplicating the set of six numbers 94, and then randomly assigning each number to a single astrological sign 96. In this embodiment, the server may generate five additional sets of six numbers, duplicate the numbers, and then redistribute the numbers in the same manner among the astrological signs 98 (following the same order as with the first set of duplicated numbers). This process should yield six unique series of numbers, which may serve as the purchased lottery numbers for the website operator. According to such embodiments, the server may then identify the various pairs of astrological signs that share, for example, the same first lottery number. Next, the website may notify all such members that share the same first lottery number (either through e-mail or by publishing such information within the website), and encourage such members to communicate with each other 100, perhaps in regards to a pre-selected topic (e.g., friendship, networking, dating, traveling, shopping, music, etc.). The foregoing embodiments will serve to increase networking among website members, increase the interest in the purchased lottery numbers, and increase traffic to and within such website.

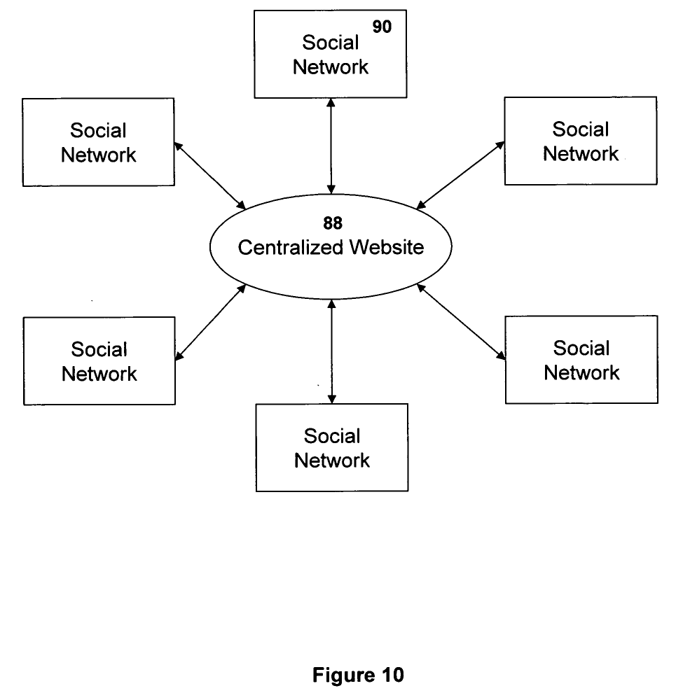

According to still further embodiments, the website described herein may comprise a personalized account page for each member. Referring to FIG. 10, the personalized account page may enable a website member to access and manage a plurality of third-party social networking sites (memberships). Many internet users today participate in a number of social networks. As such, the invention further provides a centralized website 88 in which members thereof may access and manage a plurality of such third-party social networking sites 90 (memberships). The invention provides that such feature will also serve to increase traffic towards and within the centralized website described herein.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A method for increasing website traffic, which comprises:
(a) providing a website in which a party may apply for membership;
(b) awarding membership to the party if the party submits sufficient information to a server via the website;
(c) publishing results of a potential award within the website, wherein the results of the potential award communicate to members of the website whether all of such members will share in a payment disbursement; and
(d) requiring the members of the website to view one or more pages of the website in order to view the results of the potential award.

2. The method of claim 1, wherein the results of the potential award represent an indication of (a) whether an operator of the website will itself make a payment disbursement or (b) whether the operator of the website will distribute the winnings of a successful game of chance.

3. The method of claim 2, wherein the winnings of a successful game of chance represent the lump sum payout from a winning lottery ticket.

4. The method of claim 3, wherein the payment disbursement is in the form of cash.

5. The method of claim 4, wherein the members of the website must view one or more pages of the website in order to view a set of lottery numbers selected by the operator of the website and a set of winning numbers drawn for the lottery.

6. The method of claim 1, wherein the form of the payment disbursement is selected from the group consisting of cash, rebates, and gift certificates.

7. The method of claim 6, wherein the gift certificates may only be redeemed by purchasing goods within the website.

8. The method of claim 1, wherein the party must provide his or her e-mail address and agree to periodically receive communications via said e-mail address from an operator of the website.

9. The method of claim 1, wherein the members may share equally or unequally in the payment disbursement.

10. The method of claim 9, wherein the amount of payment disbursement that a member receives depends on his or her membership level.

11. The method of claim 10, wherein a party may apply for membership to any of multiple categories of membership, whereby each category of membership offers a specific share of any payment disbursement and requires the party to fulfill specific duties to maintain an active membership within such category.

12. The method of claim 11, wherein a higher-ranked category of membership that is characterized by requiring the performance of specific duties to maintain an active membership entitles members thereof to (a) a greater share of a payment disbursement than the share awarded to members of a lower-ranked category of membership that is characterized by not requiring the performance of said specific duties or (b) a greater chance of receiving a payment disbursement relative to the chance of receiving a payment disbursement enjoyed by members of the lower-ranked category of membership.

13. The method of claim 12, wherein the specific duties are selected from the group consisting of (a) requiring a member to visit the website a certain minimum number of times during a defined period of time, (b) requiring a member to login to his or her account that is maintained within the website a certain minimum number of times during a defined period of time, (c) requiring a member to purchase a product within the website within a defined period of time, (d) referring a third party to become a member of the website, (e) entering content into a blog within a defined period of time, (f) responding to and submitting answers to surveys, and (g) any combination of the foregoing.

14. The method of claim 1, whereby in order to receive a share of the payment disbursement, the members of the website must view the results of the potential award prior to the expiration of a defined period of time.

15. A method for increasing the amount of time that visitors spend reviewing a website, which comprises:
(a) providing a website in which a party may apply for membership;
(b) awarding membership to the party if the party submits sufficient information to a server via the website;
(c) publishing the results of a potential award within the website, wherein the results of a potential award communicate to members of the website whether all of such members will share in a payment disbursement; and
(d) requiring the members of the website to view one or more pages of the website in order to view the results of the potential award.

16. The method of claim 15, wherein the results of the potential award represent an indication of (a) whether an operator of the website will itself make a payment disbursement or (b) whether the operator of the website will distribute the winnings of a successful game of chance.

17. The method of claim 16, wherein the winnings of a successful game of chance represent the lump sum payout from a winning lottery ticket.

18. The method of claim 17, wherein:
(a) the members of the website must view one or more pages of the website in order to view a set of lottery numbers selected by the operator of the website and a set of winning numbers drawn for the lottery; and
(b) the form of the payment disbursement is selected from the group consisting of cash, rebates, and gift certificates, wherein the gift certificates may only be redeemed by purchasing goods within the website.

19. The method of claim 18, wherein the members may share equally or unequally in the payment disbursement.

20. The method of claim 19, wherein the amount of payment disbursement that a member receives depends on his or her membership level, wherein:
(a) a party may apply for membership to any of multiple categories of membership, whereby each category of membership offers a specific share of any payment disbursement and requires the party to fulfill specific duties to maintain an active membership within such category;
(b) a higher-ranked category of membership that is characterized by requiring the performance of specific duties to maintain an active membership entitles members thereof to (i) a greater share of a payment disbursement than the share awarded to members of a lower-ranked category of membership that is characterized by not requiring the performance of said specific duties or (ii) a greater chance of receiving a payment disbursement relative to the chance of receiving a payment disbursement enjoyed by members of the lower-ranked category of membership;, wherein the specific duties are selected from the group consisting of (1) requiring a member to visit the website a certain minimum number of times during a defined period of time, (2) requiring a member to login to his or her account that is maintained within the website a certain minimum number of times during a defined period of time, (3) requiring a member to purchase a product within the website within a defined period of time, (4) referring a third party to become a member of the website, (5) entering content into a blog within a defined period of time, (6) responding to and submitting answers to surveys, and (7) any combination of the foregoing; and
(c) in order to receive a share of the payment disbursement, the members of the website must view the results of the potential award prior to the expiration of a defined period of time.
